(19) United States
(12) Patent Application Publication
(10) Pub. No.: US 2026/0370243 A1
(43) Pub. Date: Nov. 19, 2026

(54) RADIO FREQUENCY FRONT-END SYSTEM

(71) Applicant: Skyworks Solutions, Inc., Irvine, CA (US)

(72) Inventors: Anand Raghavan, Middleton, WI (US); Roman Zbigniew Arkiszewski, Oak Ridge, NC (US); Stephane Richard Marie Wloczysiak, Irvine, CA (US)

(21) Appl. No.: 19/676,628

(22) Filed: May 13, 2026

Related U.S. Application Data
(60) Provisional application No. 63/805,918, filed on May 14, 2025.

(51) Int. Cl. H04B 1/00; H04B 7/0413

(52) U.S. Cl. CPC H04B 1/0064; H04B 7/0413

(57) ABSTRACT

A radio frequency front-end system has at least a first primary module that includes: a set of radio frequency paths that includes a transmit path and a primary receive path for each of at least first and second bands; a set of ports that includes a plurality of antenna ports and a first secondary module port; and a switch connected between the set of radio frequency paths and the set of ports. The front-end system also includes at least a first secondary module that includes: a plurality of secondary receive paths including a first secondary receive path for each of the first and second bands; a first primary module port; and a first switch connected between the secondary receive paths and the first primary module port. The first secondary module port is coupled to the first primary module port.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57 in their entirety.

### BACKGROUND

### Field

Embodiments of the invention relate to electronic systems, and in particular, to radio frequency electronics.

### Description of Related Technology

Radio frequency (RF) communication systems can be used for transmitting and/or receiving signals of a wide range of frequencies. For example, an RF communication system can be used to wirelessly communicate RF signals in a frequency range of about 30 kHz to 300 GHz, such as in the range of about 400 MHz to about 7.125 GHz for Frequency Range 1 (FR1) of the Fifth Generation (5G) communication standard, in the range of about 24.250 GHz to about 71.000 GHz for Frequency Range 2 (FR2) of the 5G communication standard, or in the range of about 7.125 GHz to about 24.25 GHz for Frequency Range 3 (FR3).

Examples of RF communication systems include, but are not limited to, mobile phones, tablets, base stations, network access points, customer-premises equipment (CPE), laptops, and wearable electronics.

There is a need for cellular radio frequency front-end designs (e.g., mid-high band [MHB] front-ends) with increasing levels of integration and complexity for overcoming degraded RF performance.

### SUMMARY

In some aspects, the techniques described herein relate to a radio frequency front-end system including: at least a first primary module including: a set of radio frequency paths that includes a transmit path and a primary receive path for each of at least first and second bands; a set of ports that includes a plurality of antenna ports and a first secondary module port; and a switch connected between the set of radio frequency paths and the set of ports; and at least a first secondary module including: a plurality of secondary receive paths including a first secondary receive path for each of the first and second bands; a first primary module port; and a first switch connected between the secondary receive paths and the first primary module port, the first secondary module port coupled to the first primary module port thereby connecting the first primary module to the first secondary module.

In some aspects, the techniques described herein relate to a radio frequency front-end system wherein the at least a first primary module includes a first primary module and a second primary module, and the at least a first secondary module includes a first secondary module and a second secondary module, the first secondary module port of the second primary module coupled to the first secondary module port of the second primary module.

In some aspects, the techniques described herein relate to a radio frequency front-end system wherein the plurality of secondary receive paths of both of the first and second secondary modules include first and second secondary receive paths for each of the first and second bands.

In some aspects, the techniques described herein relate to a radio frequency front-end system wherein the radio frequency front-end system includes six receive paths for each of the first and second bands.

In some aspects, the techniques described herein relate to a radio frequency front-end system wherein the first and second bands are 3GPP bands 7 and 41.

In some aspects, the techniques described herein relate to a radio frequency front-end system further including N antennas each connected to one of the plurality of antenna ports, the radio frequency system capable of uninterrupted receive in at least the primary receive path for the second band while simultaneously performing sounding reference signal transmission in the first band sequentially across the N antennas.

In some aspects, the techniques described herein relate to a radio frequency front-end system wherein the at least a first primary module includes only a single primary receive path for each of the at least first and second bands, and the at least a first secondary module is a receive-only module.

In some aspects, the techniques described herein relate to a radio frequency front-end system wherein the at least a first secondary module is a multi-input multi-output (MIMO) module.

In some aspects, the techniques described herein relate to a radio frequency front-end system wherein the at least a first primary module includes a set of radio frequency paths that includes a transmit path and a primary receive path for each of at least first, second, and third bands, a first filter of the primary receive path for the second band ganged together with a second filter of the primary receive path for the third band and connected to the switch with a common connection, a third filter of the transmit path of the first band separate from the first and second filters.

In some aspects, the techniques described herein relate to a radio frequency front-end system wherein the radio frequency front-end system is configurable during sounding reference signal transmission in the first band on the transmit path of the first band on a first antenna, while simultaneously receiving on the first antenna in the second band on the primary receive path of the second band, without puncturing.

In some aspects, the techniques described herein relate to a radio frequency front-end system wherein the transmit path and the primary receive path of the for the first band are shared and include a shared frequency tunable filter.

In some aspects, the techniques described herein relate to a radio frequency front-end system wherein the at least a first primary module includes a first primary module and a second primary module, the set of radio frequency paths of the first primary module further including a transmit path and primary receive path for a third band, and the second primary module further including a primary receive path for the third band but not a transmit path, the transmit path and the primary receive path of the first primary module for the third band sharing a frequency tunable filter connected via a common connection to the switch.

In some aspects, the techniques described herein relate to a radio frequency front-end system wherein the at least a first primary module includes a first primary module and a second primary module, the set of radio frequency paths of the second primary module further including a transmit path and a primary receive path for at least a first non-terrestrial network band.

In some aspects, the techniques described herein relate to a radio frequency front-end system wherein the set of radio frequency paths of the second primary module includes a transmit path and a primary receive path for at least first and second non-terrestrial network bands, the transmit path of the first and second non-terrestrial network bands sharing a common filter connected to the switch via a common connection.

In some aspects, the techniques described herein relate to a radio frequency front-end system wherein the primary receive path for the first non-terrestrial network band shares a filter with the primary receive path of the first band, which is a cellular band.

In some aspects, the techniques described herein relate to a radio frequency front-end system wherein the set of radio frequency paths of the first primary module further includes a primary receive path for at least the first non-terrestrial network band.

In some aspects, the techniques described herein relate to a radio frequency front-end system wherein the first primary module is a packaged module and the first secondary module is a packaged module.

In some aspects, the techniques described herein relate to a radio frequency front-end system including: at least first and second primary modules each including: a set of radio frequency paths that includes a transmit path and a primary receive path for each of at least first and second bands; a set of ports that includes a plurality of antenna ports and a first secondary module port; and a switch connected between the set of radio frequency paths and the set of ports; at least first and second secondary modules each including: a plurality of secondary receive paths including a first secondary receive path for each of the first and second bands; a first primary module port; and a first switch connected between the secondary receive paths and the first primary module port, the first primary module ports of the and second first secondary modules respectively coupled to the first secondary module ports of the first and second primary modules.

In some aspects, the techniques described herein relate to a radio frequency front-end system wherein the first and second primary modules and the first and second secondary modules are each separately packaged modules.

In some aspects, the techniques described herein relate to a mobile device including: at least a first primary module including: a set of radio frequency paths that includes a transmit path and a primary receive path for each of at least first and second bands; a set of ports that includes a plurality of antenna ports and a first secondary module port; and a switch connected between the set of radio frequency paths and the set of ports; at least a first secondary module including: a plurality of secondary receive paths including a first secondary receive path for each of the first and second bands; a first primary module port; and a first switch connected between the secondary receive paths and the first primary module port, the first secondary module port coupled to the first primary module port; and a plurality of antennas each connected to a corresponding one the plurality of antenna ports.

### BRIEF DESCRIPTION OF THE DRAWINGS

FIG. 1 is a schematic diagram of one example of a communication network.

FIG. 2A is a schematic diagram of one example of a communication link using carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 3C is schematic diagram of another example of an uplink channel using MIMO communications.

FIG. 4 is a schematic diagram of an example dual connectivity network topology.

FIG. 5A is a schematic diagram of one example of a communication system that operates with beamforming.

FIG. 5B is a schematic diagram of one example of beamforming to provide a transmit beam.

FIG. 5C is a schematic diagram of one example of beamforming to provide a receive beam.

FIG. 6 shows a front-end system according to certain embodiments, including two primary front-end modules (power amplifier module with integrated duplexers [PAMiDs]) and two secondary modules (receive-only multi-input multi-output [MIMO] modules).

FIG. 6-1 shows an embodiment of a first PAMID module of the front-end system of FIG. 6.

FIG. 6-2 shows an embodiment of a second PAMiD module of the front-end system of FIG. 6.

FIG. 6-3 shows an embodiment of a first MIMO module of the front-end system of FIG. 6.

FIG. 6-4 shows an embodiment of a second MIMO module of the front-end system of FIG. 6.

FIGS. 7A-7B show configurations of the first PAMiD module of the front-end system of FIG. 6 during sounding reference signal (SRS) transmission.

FIG. 8 is a schematic diagram of one embodiment of a mobile device incorporating a front-end system according to embodiments described herein, such as the front-end system of FIG. 6 or 7A-7B.

### DETAILED DESCRIPTION OF EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15, and plans to introduce Phase 2 of 5G technology in Release 16 (targeted for 2020). Subsequent 3GPP releases will further evolve and expand 5G technology. 5G technology is also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

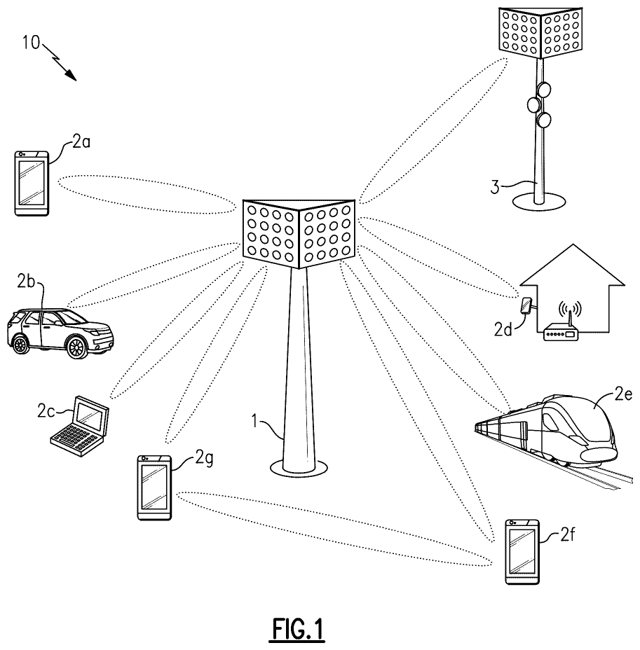

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul.

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1), Frequency Range 2 (FR2), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz. Cellular user equipment can communicate using beamforming and/or other techniques over a wide range of frequencies, including, for example, FR2-1 (24 GHz to 52 GHZ), FR2-2 (52 GHz to 71 GHz), and/or FR1 (400 MHz to 7125 MHz).

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

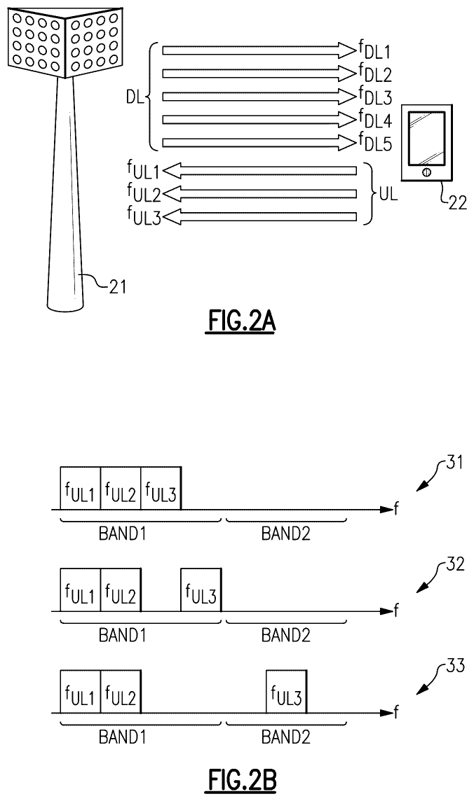

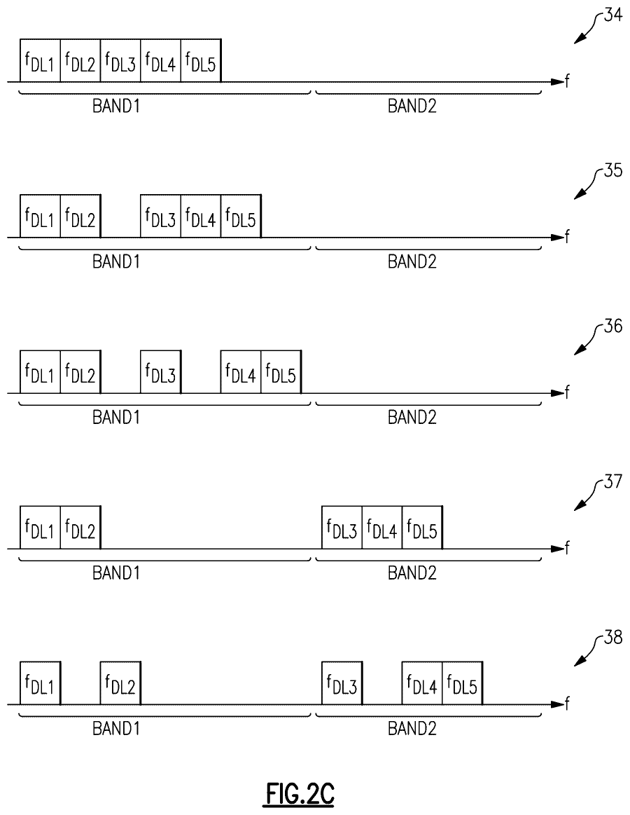

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2A, the uplink channel includes three aggregated component carriers fUL1, fUL2, and fUL3. Additionally, the downlink channel includes five aggregated component carriers fDL1, fDL2, fDL3, fDL4, and fDL5. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier fUL1, a second component carrier fUL2, and a third component carrier fUL3. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers fUL1, fUL2, and fUL3 that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers fUL1, fUL2, and fUL3 that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers fUL1 and fUL2 of a first frequency band BAND1 with component carrier fUL3 of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier fDL1, a second component carrier fDL2, a third component carrier fDL3, a fourth component carrier fDL4, and a fifth component carrier fDL5. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink. Furthermore, NR-U can operate on top of LAA/eLAA over a 5 GHz band (5150 to 5925 MHz) and/or a 6 GHz band (5925 MHz to 7125 MHz).

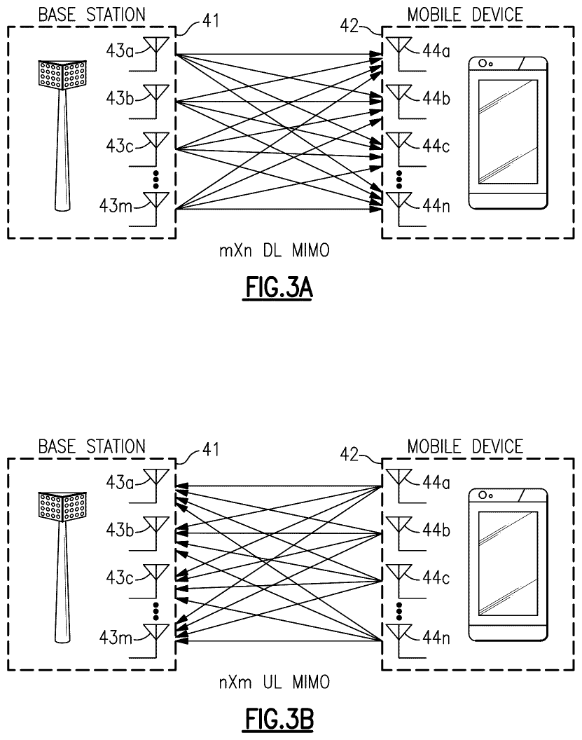

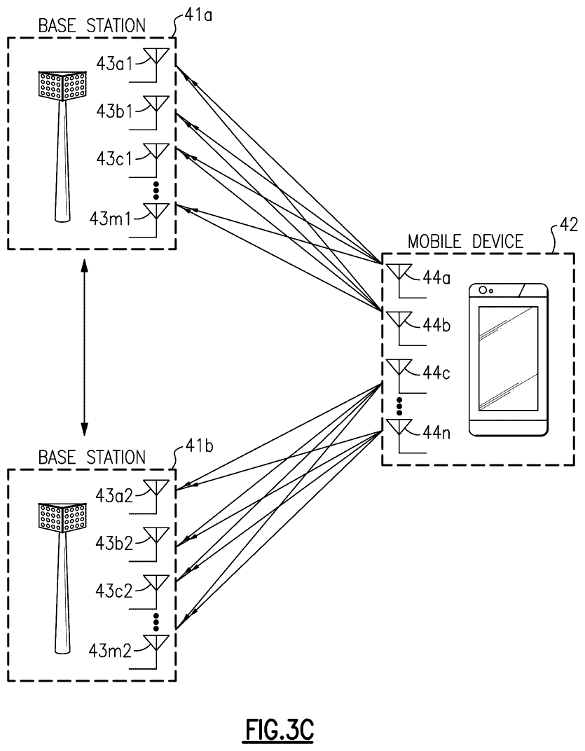

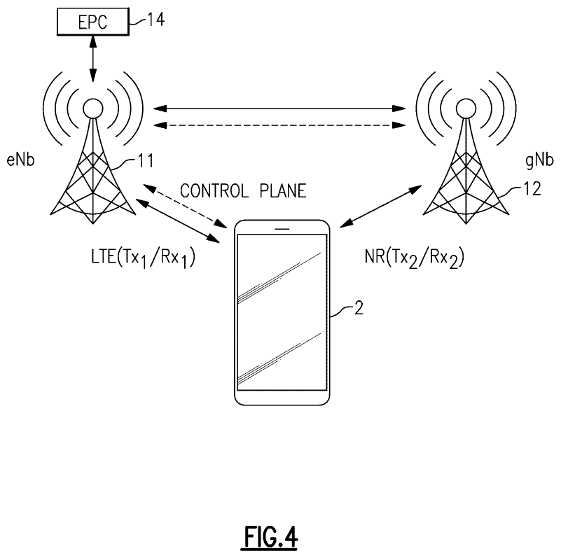

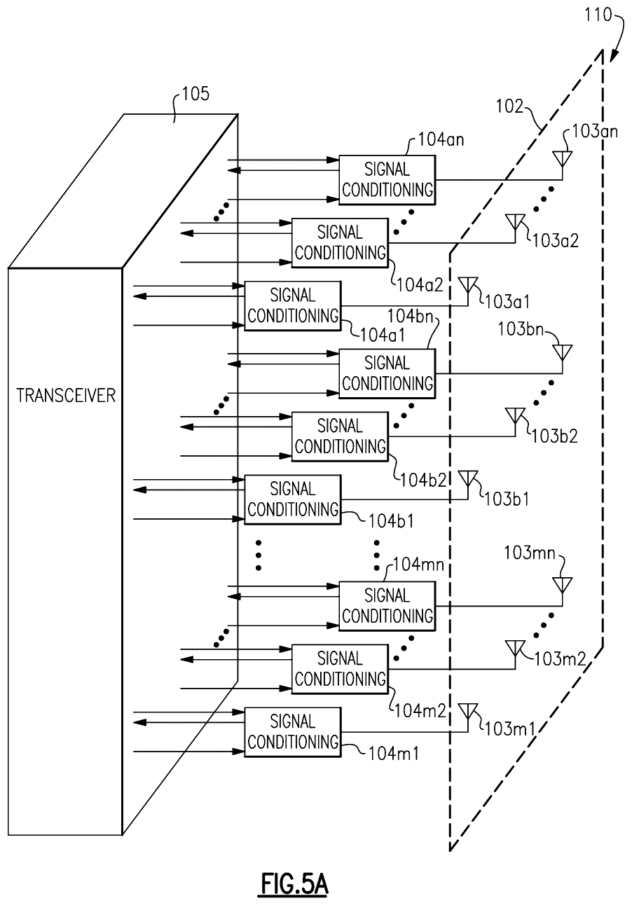

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of m×n DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of n×m UL MIMO.

By increasing the level or order of MIMO, bandwidth of an uplink channel and/or a downlink channel can be increased.

MIMO communications are applicable to communication links of a variety of types, such as FDD communication links and TDD communication links.

FIG. 3C is schematic diagram of another example of an uplink channel using MIMO communications. In the example shown in FIG. 3C, uplink MIMO communications are provided by transmitting using N antennas 44a, 44b, 44c, . . . 44n of the mobile device 42. Additional a first portion of the uplink transmissions are received using M antennas 43a1, 43b1, 43c1, . . . 43m1 of a first base station 41a, while a second portion of the uplink transmissions are received using M antennas 43a2, 43b2, 43c2, . . . 43m2 of a second base station 41b. Additionally, the first base station 41a and the second base station 41b communication with one another over wired, optical, and/or wireless links.

The MIMO scenario of FIG. 3C illustrates an example in which multiple base stations cooperate to facilitate MIMO communications.

FIG. 4 is a schematic diagram of an example dual connectivity network topology. This architecture can leverage LTE legacy coverage to ensure continuity of service delivery and the progressive rollout of 5G cells. A UE 2 can simultaneously transmit dual uplink LTE and NR carrier. The UE 2 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 1. The eNB 11 can provide a connection with a core network, such as an Evolved Packet Core (EPC) 14. The gNB 12 can communicate with the core network via the eNB 11. Control plane data can be wireless communicated between the UE 2 and eNB 11. The eNB 11 can also communicate control plane data with the gNB 12. Control plane data can propagate along the paths of the dashed lines in FIG. 4. The solid lines in FIG. 4 are for data plane paths.

In the example dual connectivity topology of FIG. 4, any suitable combinations of standardized bands and radio access technologies (e.g., FDD, TDD, SUL, SDL) can be wirelessly transmitted and received. This can present technical challenges related to having multiple separate radios and bands functioning in the UE 2. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

E-UTRA New Radio Dual Connectivity (EN-DC) can involve both 4G and 5G carriers being simultaneously transmitted from a UE. Transmitting both 4G and 5G carriers in a UE, such as a phone, typically involves two power amplifiers (PAs) being active at the same time. Traditionally, having two power amplifiers active simultaneously would involve the placement of one or more additional power amplifiers specifically suited for EN-DC operation. Additional board space and expense is incurred when designing to support such EN-DC/NSA operation.

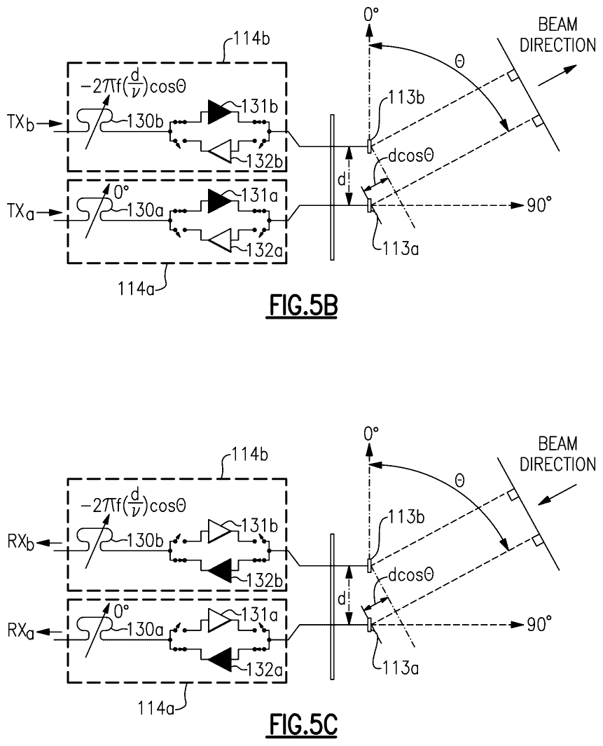

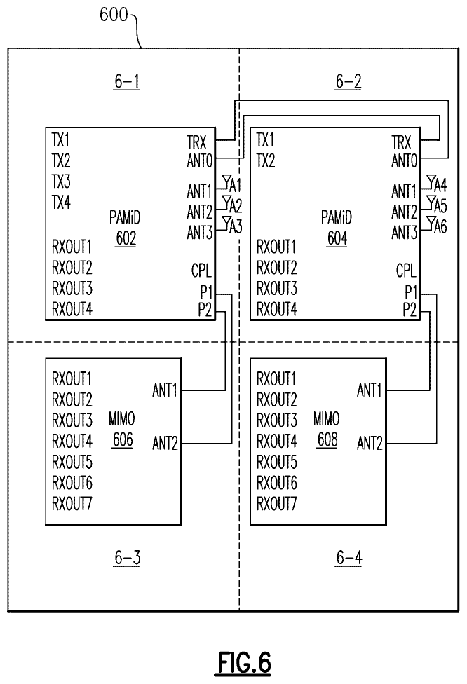

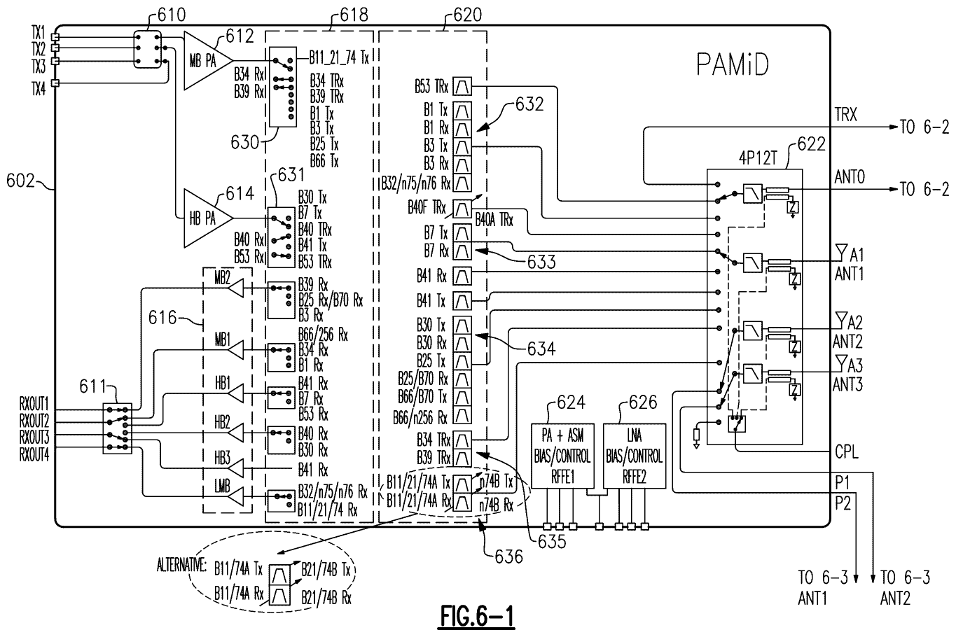

FIG. 5A is a schematic diagram of one example of a communication system 110 that operates with beamforming. The communication system 110 includes a transceiver 105, signal conditioning circuits 104a1, 104a2 . . . 104an, 104b1, 104b2 . . . 104bn, 104 m1, 104m2 . . . 104mn, and an antenna array 102 that includes antenna elements 103a1, 103a2 . . . 103an, 103b1, 103b2 . . . 103bn, 103m1, 103m2 . . . 103mn.

Communications systems that communicate using millimeter wave carriers (for instance, 30 GHz to 300 GHz), centimeter wave carriers (for instance, 3 GHz to 30 GHz), and/or other frequency carriers can employ an antenna array to provide beam formation and directivity for transmission and/or reception of signals.

With respect to signal transmission, the signal conditioning circuits can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal propagates for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits and processes signals received from the signal conditioning circuits. As shown in FIG. 5A, the transceiver 105 generates control signals for the signal conditioning circuits. The control signals can be used for a variety of functions, such as controlling the gain and phase of transmitted and/or received signals to control beamforming.

FIG. 5B is a schematic diagram of one example of beamforming to provide a transmit beam. FIG. 5B illustrates a portion of a communication system including a first signal conditioning circuit 114a, a second signal conditioning circuit 114b, a first antenna element 113a, and a second antenna element 113b.

Although illustrated as included two antenna elements and two signal conditioning circuits, a communication system can include additional antenna elements and/or signal conditioning circuits. For example, FIG. 5B illustrates one embodiment of a portion of the communication system 110 of FIG. 5A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 131b, a second LNA 132b, and switches for controlling selection of the power amplifier 131b or LNA 132b.

Although one embodiment of signal conditioning circuits is shown, other implementations of signal conditioning circuits are possible. For instance, in one example, a signal conditioning circuit includes one or more band filters, duplexers, and/or other components.

In the illustrated embodiment, the first antenna element 113a and the second antenna element 113b are separated by a distance d. Additionally, FIG. 5B has been annotated with an angle ⊖, which in this example has a value of about 90° when the transmit beam direction is substantially perpendicular to a plane of the antenna array and a value of about 0° when the transmit beam direction is substantially parallel to the plane of the antenna array.

By controlling the relative phase of the transmit signals provided to the antenna elements 113a, 113b, a desired transmit beam angle ⊖ can be achieved. For example, when the first phase shifter 130a has a reference value of 0°, the second phase shifter 130b can be controlled to provide a phase shift of about −2πf(d/v) cos⊖ radians, where f is the fundamental frequency of the transmit signal, d is the distance between the antenna elements, v is the velocity of the radiated wave, and x is the mathematic constant pi.

In certain implementations, the distance d is implemented to be about ½λ, where λ is the wavelength of the fundamental component of the transmit signal. In such implementations, the second phase shifter 130b can be controlled to provide a phase shift of about −πcos⊖ radians to achieve a transmit beam angle ⊖.

Accordingly, the relative phase of the phase shifters 130a, 130b can be controlled to provide transmit beamforming. In certain implementations, a baseband processor and/or a transceiver (for example, the transceiver 105 of FIG. 5A) controls phase values of one or more phase shifters and gain values of one or more controllable amplifiers to control beamforming.

FIG. 5C is a schematic diagram of one example of beamforming to provide a receive beam. FIG. 5C is similar to FIG. 5B, except that FIG. 5C illustrates beamforming in the context of a receive beam rather than a transmit beam.

As shown in FIG. 5C, a relative phase difference between the first phase shifter 130a and the second phase shifter 130b can be selected to about equal to −2πf(d/v) cos⊖ radians to achieve a desired receive beam angle ⊖. In implementations in which the distance d corresponds to about ½λ, the phase difference can be selected to about equal to −πcos⊖ radians to achieve a receive beam angle ⊖.

Although various equations for phase values to provide beamforming have been provided, other phase selection values are possible, such as phase values selected based on implementation of an antenna array, implementation of signal conditioning circuits, and/or a radio environment.

In cellular networks, such as 5G networks, sounding reference signal (SRS) features can be enabled to determine channel qualities of a communication link between user equipment (UE) (for example, a wireless device such as a mobile phone) and a base station. SRS symbols are transmitted on uplink and processed by the network to estimate the quality of the wireless channel at different frequencies. For instance, the SRS symbols transmitted by the UE can be used by the base station to estimate the quality of the uplink channel for large bandwidths outside the assigned frequency span to the UE.

For the case of 4×4 MIMO, SRS relies on the transmission in uplink (UL) of known symbols to each of four receive antennas. By receiving each of these known transmissions from each antenna, the gNodeB base station can develop an accurate channel model for the RF path from each of the antennas back to the gNodeB. Additionally, with respect to downlink (DL), the reciprocal nature of the UL and DL in TDD enables a much better transfer function for each of the antenna RF channel models, and the SNR can be significantly improved for both higher order MIMO as well as higher order receive (Rx) diversity.

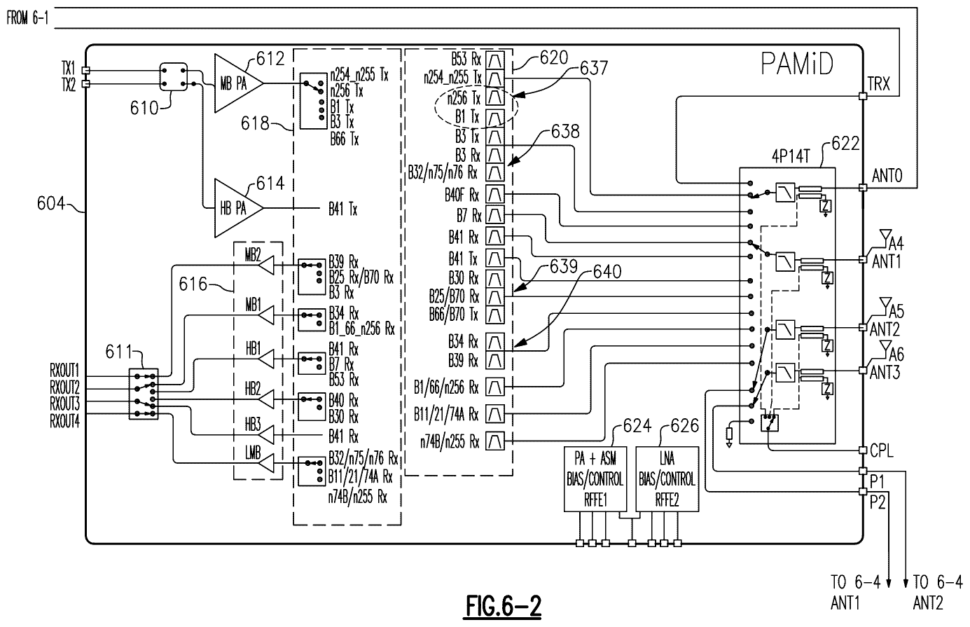

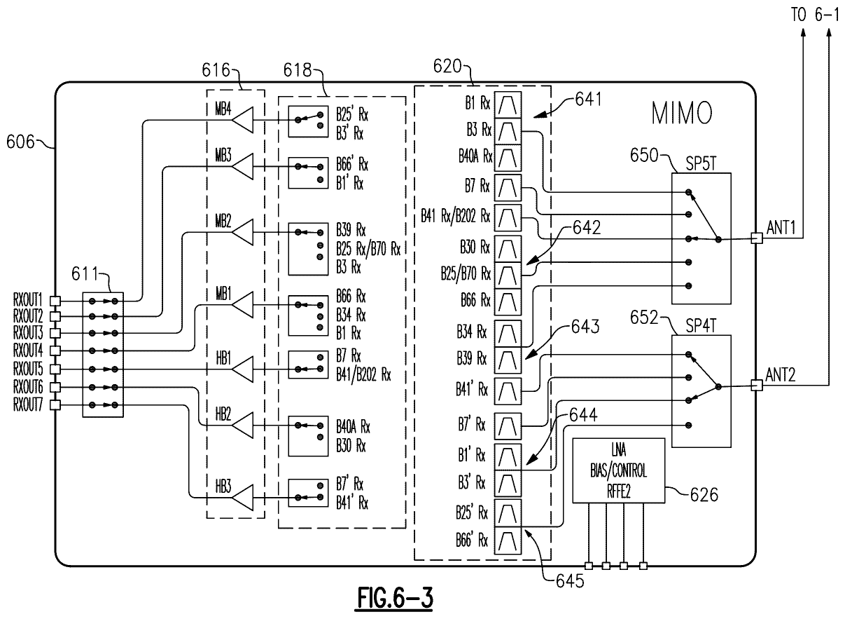

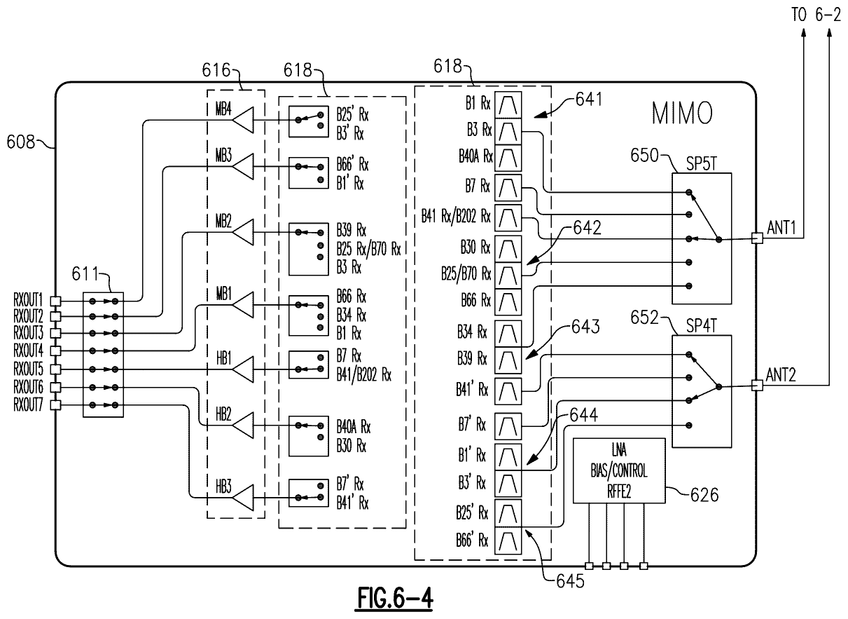

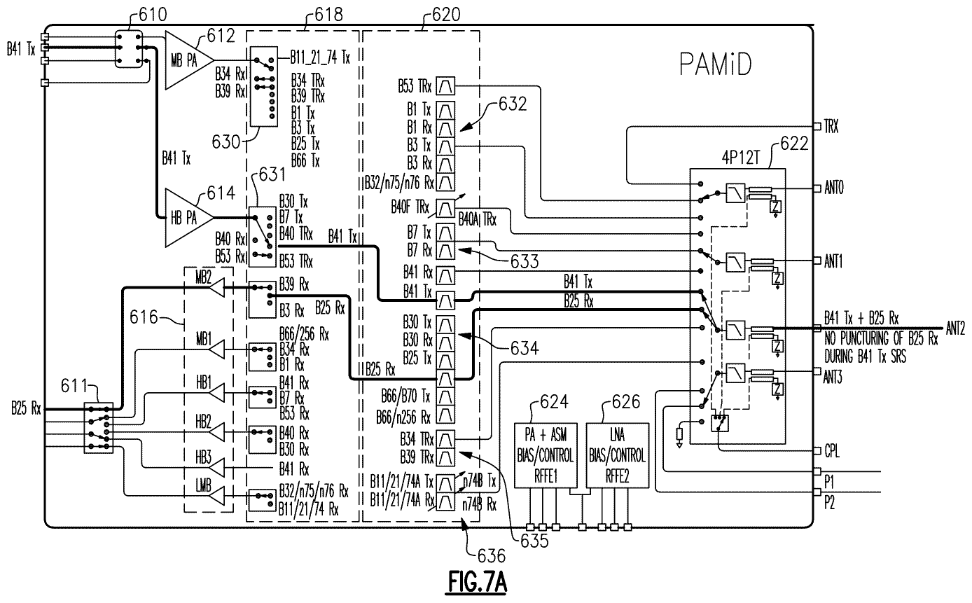

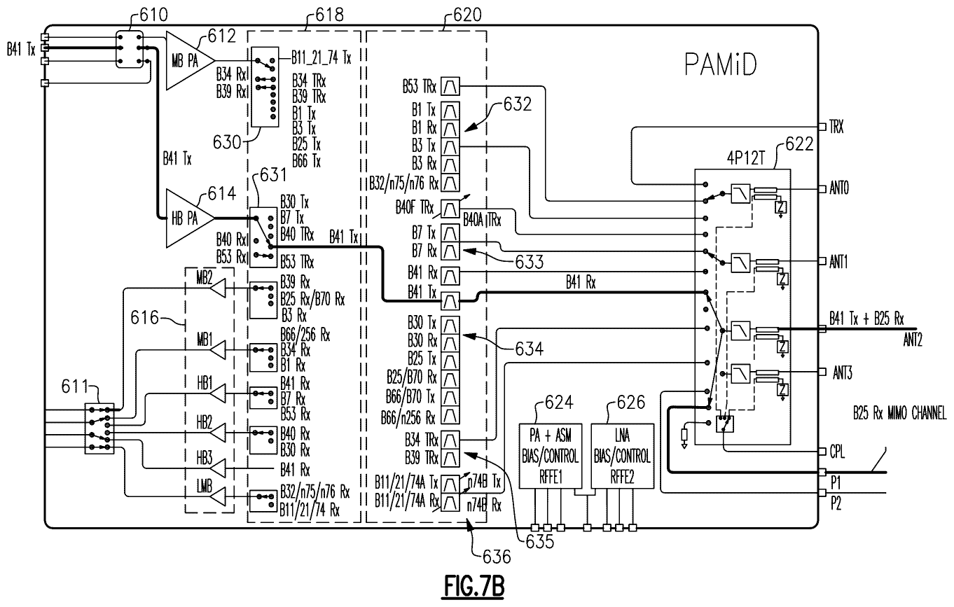

For example, embodiments described herein, including those of FIGS. 6 and 7A-7B, provide a front end capable of up to 6 Rx in certain bands, where SRS relies on transmission in uplink of known symbols to up to six receive antennas.

### MHB Front-End Architecture

Front-end systems can be used to process signals of a wide range of frequencies. For example, certain front-end systems can operate using one or more low bands (for example, RF signal bands having a frequency content of 1 GHz or less, also referred to herein as LB), one or more mid bands (for example, RF signal bands having a frequency content between 1 GHz and 2.3 GHZ, also referred to herein as MB), one or more high bands (for example, RF signal bands having a frequency content between 2.3 GHz and 3 GHz, also referred to herein as HB), and/or various 5G frequency bands such as n41, n77 or n79. MHB frequency content refers to frequency content covering at least a portion of MB and at least a portion of HB, for instance, a frequency content between 1 GHz and 3 GHz.

According to certain embodiments, such as those shown and described with respect to FIGS. 6-7B, front-end systems are provided herein that achieve high levels of integration between RF modules with minimal or reduced size and cost, while providing acceptable amounts of RF electromagnetic isolation between different bands, channels/RF paths, and transmitters and receivers. Certain embodiments add higher-order diversity receive signal paths/circuits and integrate a satellite connectivity bands (e.g., non-terrestrial network [NTN] bands), and can implement extensive filter re-use and co-banding.

Moreover, such front-end systems can reduce downlink performance degradation when some bands (e.g., during carrier aggregation or E-UTRAN New Radio Dual Connectivity [ENDC] operation) are paired with TDD bands and reduce or eliminate RF puncturing associated with SRS-AS signaling. Embodiments described herein can achieve such advantages while controlling module size or cost, e.g., by including higher-order diversity receive circuits, achieving increased isolation/separation of receive circuits from transmitter circuits, and by enhanced integration strategy. NTN band content can also be supported using standalone power amplifiers, filters, low-noise amplifiers, and band-switches.

According to certain embodiments, TDD band transmitter circuitry (e.g., power amplifiers, band switches, and transmit filters) are connected directly to a switch such as an antenna switch module (ASM), which connects them to antennas. The ASM can control and configure all CA/EN-DC filter multiplexing operations, including those involving certain TDD bands. As a result, embodiments described herein reduce or eliminate interruption of paired-band receive paths due to switch reconfiguration during SRS-AS.

Moreover, where a paired band supports n receiver paths, m is the total number of MHB antennas capable of supporting the paired band, and n<m, certain embodiments allow for some of the paired-band receive paths to connect to different antennas than the TDD band receivers performing SRS-AS, thereby reducing or eliminating receive band interruption during SRS.

The front-end systems described herein can support NTN band content while leveraging filter re-use and co-banding to minimize size/cost. For example, embodiments described herein can support some or all of the following, e.g., while minimizing the number of power amplifiers, band-switches, pre-LNA switches as compared to other architectures:
n254 transmit support by co-banding with n255 transmit.
n255 receive support by co-banding with n74B receive.
n256 transmit support by a filter that switches between n1 transmit mode and n256 transmit mode.
n256 receive co-banding with a combined n1/n66 filter.

According to certain embodiments, high-order diversity receive circuits are integrated into MIMO modules that only feature receive paths and no transmit paths, providing transmit/receive separation in the front-end system. This can enable reduced module size, e.g., by employing vertical filter-stacking technologies that limit lateral area footprint, while achieving increased transmit receive EM isolation.

FIG. 6 shows a front-end system 600 according to certain embodiments. The front-end system 600 can be included in a mobile device such as a smart phone, and which can be any of the mobile devices and other types of user equipment described herein.

The front-end module 600 includes a first power amplifier module with integrated duplexer (PAMiD) 602, a second PAMID 604, a first MIMO module 606, and a second MIMO module 608. The first and second PAMiDs 602, 604 may be referred to as primary modules because they include the primary transmit and receive paths for each band, whereas the first and second MIMO modules 604, 608 may be referred to as receive-only modules because they include only receive paths. The first and second MIMO modules 606, 608 can additionally or alternatively be referred to as diversity modules or secondary modules.

As shown, the first PAMID module 602 includes transmit ports TX1-TX4, some or all of which can be connected to a transceiver or other appropriate component to receive transmit input signals. The first PAMID module 602 also has four receive ports RXOUT1-RXOUT4 for outputting four receive signals (e.g., to the transceiver) and a port ANT0 connected to the TRX port of the second PAMiD 606. Ports ANT1-ANT3 are connected to three antennas A1, A2, and A3 of the mobile device or other UE on which the front-end system 600 resides. Because the three ports ANT1-ANT3 of the first PAMID 602 are connected to the antennas A1-A3, these ports can be referred to as the antenna ports of the first PAMID module 602.

The second PAMID module 604 includes transmit input signals via two transmit ports TX1-TX2 (e.g., from the transceiver), and includes four receive ports RXOUT1-RXOUT4 for outputting four signals (e.g., to the transceiver). The second PAMID 604 also includes a port ANT0 connected to a TRX port of the first PAMID module 602. Ports ANT1-ANT3 are connected to three additional antennas A4, A5, and A6 of the mobile device. Because the three ports ANT1-ANT3 of the first PAMID 604 are connected to the antennas A4-A6, these ports can be referred to as the antenna ports of the second PAMID module 604.

The first MIMO module 606 outputs receive signals (e.g., to the transceiver) via seven ports RXOUT1-RXOUT7. The second MIMO module 608 outputs receive signals (e.g., to the transceiver) via seven ports RXOUT1-RXOUT7.

As shown, the front-end system 600 can include inter-module connectivity. For instance, port ANT0 of the first PAMID 602 is connected to the TRX port of the second PAMID 604, and port ANT0 of the second PAMID 604 is connected to the TRX port of the first PAMiD 602, thereby allowing the first PAMID 602 and the second PAMID 604 to share antennas and transmit/receive content.

In addition, the first PAMiD 602 is connected via ports P1, P2 to the ports ANT2, ANT1 of the first MIMO module 606, and the second PAMID 604 is connected via ports P1, P2 to the ports ANT2, ANT1 of the second MIMO module 608, thereby allowing the first PAMiD 602 to route receive signal content from the first PAMID 602 to the first MIMO module 606 and allowing the second PAMID 604 to route receive signal content from the second PAMiD 604 to the second MIMO module 608. Thus, the ports ANT0, TRX, P1, and P2 of the first and second PAMiDs can be referred to as inter-module ports.

FIGS. 6-1, 6-2, 6-3, and 6-4 respectively depict the first PAMID 602, the second PAMID 604, the first MIMO module 606, and the second module 608 of the front-end system 600 of FIG. 6 according to certain embodiments.

Referring to FIG. 6-1, as shown, the first PAMID 602 includes a mid-band power amplifier 612 (e.g., a GaAs power amplifier), a high-band power amplifier 614 (e.g., a GaAs power amplifier), a transmit switch 610, a set of receive amplifiers 616 (e.g., GaAs low noise amplifiers), a receive switch 611, a set of band select switches 618, a set of filters 620, a switch 622, a first control circuit 624, and a second control circuit 626.

The transmit switch 610 can be configured to selectively connect one of the transmit inputs TX1-TX3 to the mid-band power amplifier 612 and another of the transmit inputs TX1-TX3 to the high-band power amplifier 614. The switch 610 can also be configured to route one of the transmit inputs TX1-TX3 to the TX4 port. In another embodiment, TX4 can be an additional input port, and the switch can selectively connect one of TX1-TX4 to each of the two transmit amplifiers 612, 612, depending on the transmit mode.

The mid-band amplifier 612 is connected to a first band select switch 630 of the set of band select switches 618, and the high-band amplifier 614 is connected to a second band select switch 631.

In the illustrated embodiment, the mid-band amplifier 612 is capable of transmitting in the following bands: B1, B3, B11, B21, B25, B34, B39, B66, and B74. Depending on the currently transmitting band, the first transmit band select switch 630 is configured to selectively couple the output of the mid-band power amplifier 612 to a combined port for bands B11, B21, B74 or any of its separate ports for bands B1, B3, B25, B34, B39, or B66. In turn, while the connections are not shown for the purposes of simplicity of illustration, the ports of the first switch 630 and other switches in the set of band-select switches 618 are coupled to the corresponding filter in the set of filters 620, as indicated by matching labels on the ports of the switch 630 and corresponding filters in the set of band filters 620.

For TDD bands 34 and 39, the right-side ports of the first band select switch 618 can be used during both transmit and receive, and the first switch 630 can therefore be further configured during TDD receive to connect the right-side port of the switch 630 for that band (B34 TRx or B39 TRx) to the corresponding left-side port of the switch 630 for that band (B34 Rx or B39 Rx). Moreover, as indicated by the labels, the left-side port (B34 Rx or B39 Rx) of the transmit band select switch 630 can be connected to the right side port (B34 Rx or B39 Rx) of an appropriate receive band select switch in the set of band select switches 618. For example, B34 Rx is connected to the same receive band select switch as B66/256 Rx and B1 Rx, and B39 Rx is connected to the same receive band select switch as B25Rx/B70Rx and B3 Rx.

The illustrated high-band amplifier 614 is capable of transmitting in the following bands: B7, B30, B40, B41, and B53. Depending on the currently transmitting band, the second transmit band select switch 631 is configured to selectively couple the output of the high-band power amplifier 614 to any of the separate ports of the switch 631 for bands B7, B30, B40, B41, and B53. In turn, while the connections are not shown for the purposes of simplicity of illustration, the outputs of the second switch 631 are coupled to the corresponding filter in the set of filters 620, as indicated by matching labels.

For TDD bands 40 and 53, the right-side ports of the switch 631 can double as transmit and receive ports, and the second switch 631 can be further configured during B40 or B53 Rx to connect the right-side port for that band (B40 TRx or B53 TRx) to the corresponding left-side port for that band (B40 Rx or B53 Rx). Moreover, as indicated by the labels, the left-side port (B40 Rx or B53 Rx) of the switch 631 can be connected to the input (right side ports) of the appropriate receive band select switches in the set of band select switches 618, with B40 Rx connected to the same receive band select switch as B30 Rx, and B53 Rx connected to the same receive band select switch as B41Rx and B7 Rx.

The illustrated set of band filters 620 is grouped into nine separate groups, with four independent filters for B53 TRx, B40 TRx, B41 Rx, and B41 Tx, which can each be in its own separate package, and can each form a separate surface mount device. The band filters 620 additionally includes five multiplexer filters 631-636, including a pentaplexer 632, diplexer 633, hexaplexer 634, diplexer 635, and diplexer 636. Each multiplexer 631-636 can be housed in a package, e.g., with the constituent filters permanently ganged together within the package. Some or all of the band filters 620 can comprise acoustic wave filters (e.g., bulk acoustic wave [BAW] or surface acoustic wave [SAW] filters).

Each of the nine filters in the set of band filters 620 is connected to a corresponding port in the switch 622, which can be referred to an antenna switch module (ASM). The switch 622 in the illustrated embodiment is a 4P12T (4-pole, 12-throw switch), with the four poles each connected to one of the ports ANT0, ANT1, ANT2, ANT3. The switch 622 can be controlled to selectively connect the 12 throws to the 9 the nine band filters 620 filters, to port P1, which is connected to port ANT2 of the first MIMO module 606, to port P2, which is connected to port ANT1 of the first MIMO module 606, or to the TRX port, which is connected to the second PAMID module 604. The switch 622 can also be configured for switch-combining of multiple ones of the 12 ports of the switch 622 to a given antenna, e.g., for carrier aggregation (CA) modes. While switch 622 in the illustrated embodiment is integrated within a single package, in other implementations the switch 622 may be functionally integrated but physically distributed across multiple switches residing in separate packages.

The six receive filters 616 can each comprise an LNA filter configured for a different band group (low-mid band LMB, mid-band 1 MB1, mid-band 2 MB2, high-band 1 HB1, high-band 2 HB2, and high-band 3 HB3 in the illustrated embodiment), and each can receive an output from a corresponding one of the receive band select switches in the set of band select switches 618. The receive switch 611 receives the six amplified receive signals and selectively connects the receive signals to the four receive outputs RXOUT1-RXOUT4.

The antenna switch 622, the band select switches 618, the receive switch 611, and/or the transmit switch 610 according to certain embodiments can be silicon-on-insulator (SOI) switches manufactured with an SOI process, or with another semiconductor technology.

The first control circuit 624 can be configured to control and bias the power amplifier and to control the antenna switch 622 and the second control circuit 626 can be configured to bias and control the receive amplifiers 616, although a common control circuit can be implemented in other embodiments. The first and/or second control circuits 624, 626 can also be configured to control the transmit switch 610, receive switch 611, and band-select switches 618.

As shown, certain paths in the first PAMID 602 are shared, including for B32/n75/n76 Rx, B11/21/74 Tx, B11/21/74 Rx, B25/B70 Rx, B25/B70 Tx, and B66/n256 Rx.

In addition, the set of band filters 620 includes multiple frequency tunable filters, including the B40 TRx filter, which is tunable for B40F carrier aggregation operation (with reduced WiFi coexistence capabilities) or B40A standalone operation (with greater WiFi coexistence capabilities). This allows for covering B40A and B40F with a single filter die with switch-controlled or tunable filter operation that effectively moves the B40F high-corner (e.g., about 2400 MHz.) to the lower B40A corner (e.g., about 2370 MHz approx.).

The diplexer 636 can be tunable to cover both B11/B21/n74A, and n74B, where n74A and n74B can be sub-bands within n74. For instance, an a first switch mode, the diplexer 636 can be configured for n74B Tx and Rx, and in a second switch mode the diplexer 636 can be configured for B11/B21/n74A Tx and Rx. n74A can spans 1427-1460 MHz Tx and 1475-1508 Rx and n74B can span 1440-1470 MHz Tx and 1488-1518 Rx. Thus, in a first switch mode, the diplexer 636 is set to Tx=1427-1470, Rx=1488-1518 to cover n74B, and in a second switch mode, the diplexer 636 is set to Tx=1427-1463 MHz (high-edge switched lower from the first mode) and Rx=1475-1518 (low-edge switched lower than the first mode). This covers n74A/B11/B21. As shown, in an alternative embodiment, the diplexer 636 may be configured as a switched filter with the following 2 switch modes having different tuned frequencies: Model: B11/n74A Tx and Rx and Mode 2: B21/n74B (Tx and Rx).

As shown in FIG. 6-2, the second PAMID module 604 can be generally similar to the first PAMID module 602. The second PAMiD module 604 of the illustrated embodiment, however, includes only two transmit inputs TX1, TX2, which are selectively connected by the transmit switch 610 to one of the mid-band power amplifier 612, or the high-band amplifier 614. The mid-band amplifier 612 can configured to transmit in bands B1, B3, B66, n254, n255, or n256. As shown, n254 and n255 share a common transmit path and thus a common output port on the first transmit band select switch. The high-band power amplifier 614 is capable of transmitting in only B41, and thus connects directly to the corresponding filter in the set of band filters 620 without an intermediate switch.

As compared to the first PAMID 602, the second PAMID 604, like the first PAMiD 602, transmits in B1, B3, B41, and B66. However, unlike the first PAMID 602, the second PAMiD 604 transmits in the following additional bands n254, n255, n256 (non-terrestrial network [NTN] bands), and is not capable of transmitting in B7, B11, B21, B25, B30, B39, B40, B53, and n74.

The band filters 620 of the second PAMID 604 are grouped into seven independent filters as follows: 1) n74B/n255 Rx; 2) B11/21/74A Rx; 3) B1/66/n256 Rx; 4) B41 Tx; 5) B41 Rx; 6) B7 Rx; and 7) B40F Rx; and four multiplexers 637-640 as follows: 1) triplexer 637; 2) quadplexer 638; 3) triplexer 639; and 4) diplexer 640. Each multiplexer 637-640 can be housed in a package, e.g., with the constituent filters permanently ganged together within the package. Some or all of the band filters 620 can comprise acoustic wave filters (e.g., BAW or SAW filters).

Like the first PAMID 602, the second PAMiD 604 includes six receive amplifiers 616 selectively connected to four receive outputs RXOUT1-RXOUT4 by the receive switch 611.

The switch 622 of the second PAMID is a 4P14T (4 pole, 14 throw switch), with the four poles each connected to one of the ports ANT0, ANT1, ANT2, ANT3. The switch 622 can be controlled to selectively connect the 14 throws to the 11 band filters of the set of band filters 620 filters, to port P1, which is connected to port ANT2 of the second MIMO module 608, to port P2, which is connected to port ANT1 of the second MIMO module 608, or to the TRX port, which is connected to the second PAMID module 604. Moreover, the switch 622 can be configured to switch-combine multiple ones of the 14 ports to any one antenna, e.g., to support CA modes.

As shown, certain paths in the second PAMID 604 are shared, including n254/n255 Tx, B32/n75/n76 Rx, B25/B70 Rx, B66/B70 Tx, B1/B66/n256 Rx, B11/B21/n74A Rx, and n74B/n255 Rx.

As shown in FIG. 6-3, the first MIMO module 606 includes a receive switch 611, which can selectively connect the outputs of seven receive amplifiers 616 to seven receive outputs RXOUT1-RXOUT7. The amplifiers 616 are each connected to a corresponding one of the band select switches 618. As shown, some of the receive paths are shared, including B25 Rx/B70Rx and B41 Rx/B202 Rx.

While the connections are not shown for simplicity of illustration, as indicated by matching labels, inputs of the receive switches 618 are connected to the outputs of corresponding filters in the set of filters 620. The illustrated set of band filters 620 is grouped into nine separate groups, with four independent filters for B7 Rx, B41/B202 Rx, B30 Rx, B41′ Rx, and B7′ Tx, which can each be in its own separate package, and can each form a separate surface mount device. The band filters 620 additionally include five multiplexer filters 641-645, including a triplexer 641, triplexer 642, diplexer 643, diplexer 644, and diplexer 645. Each multiplexer 641-645 can be housed in a package, e.g., with the constituent filters permanently ganged together within the package. Some or all the band filters 620 can comprise acoustic wave filters (e.g., bulk acoustic wave [BAW] or surface acoustic wave [SAW] filters).

As shown, a first subset of the filters 620 are connected to a first switch 650, which in the illustrated embodiment is an SP5T (single-pole, 5 throw) switch configured to connect the port ANT1 of the first PAMID 602 to one or multiple ones of the five output ports of the first switch 650, and thus to one or multiple ones of the five filters of the group of band filters 620 connected to the first switch 650.

Similarly, a second subset of the band filters 620 are connected to a second switch 652, which in the illustrated embodiment is an SP4T (single-pole, 4 throw) switch configured to connect the port ANT2 coming from the first PAMID 602 to one or multiple ones of the four output ports of the second switch 652, and thus to one or multiple ones of the four filters of the group of band filters 620 connected to the second switch 652.

The control circuit 626 can be configured to control some or all of the amplifiers 616, the receive switch 611, and the first and second switches 650, 652. Depending on the operating mode, the first and second switches 650, 652 and the band switches 618 can be configured to pass at least seven bands simultaneously to the receive switch 611.

In the illustrated embodiment, the second MIMO module 608 is configured the same as the first MIMO module 606, although the two MIMO modules 606, 608 can be configured differently from one another in other implementations.

As shown, the first and second PAMiDs 602, 604 of the illustrated embodiment include only primary receive paths for the supported bands, and additional receive paths are kept out of the PAMiDs 602, 604 (e.g., the additional diversity receive DRx paths) and included instead in the MIMO modules 606, 608. This allows for reduced size/complexity and avoids electromagnetic sneak pathways that can reduce radio frequency isolation, among providing other benefits.

As shown, first and second MIMO modules 606, 608 provide multiple diversity receive paths (DRx) for a number of bands, including B1/B1′, B3/B3′, B7/B7′, B25/B25′, B41/B41′, and B66/B66′. When combined with the primary receive paths for these bands in the first and second PAMiD modules 602, 604, the front-end system 600 can be configured to provide full 6 receive (6 Rx) carrier aggregation (CA) support. For example, the front-end system 600 can be configured for 6 Rx CA for B25/B66/B41, B1/B3/B41, B25/B7, B1/B3/B7, etc.).

As one illustrative example, to achieve 6 Rx CA for B25/B66/B41, A1/ANT1 of the first PAMID module 602 can detect a channel of B25/B66/B41 Rx. The switch 622 switch-combines the pentaplexer 634 and the B41 Rx filter to ANT1. The appropriate receive amplifiers 616 (e.g., MB2 for B25, MB1 for B66, and HB1 and/or HB3 for B41) receive the filtered signals and output the signals on at least three of the outputs ROUT1-RXOUT4 selected by the switch 611. The antenna A2/ANT2 detects another channel of B25/B66/B41 Rx, and the switch 622 connects ANT2 to P2. Thus, referring now to FIG. 6-3, the channel is received at antenna A1/ANT1 of the first MIMO module 606, and the switch 650 switch-combines the triplexer 642 and the B41Rx/B202 Rx filter to ANT1. The corresponding band switches in the set of band switches 618 receive the filtered signals and output the filtered signals to the corresponding receive amplifiers in the group of receive amplifiers 616 (e.g., B25 Rx to MB2, B66 Rx to MB1, B41 Rx to HB1). The receive switch 611 connects the outputs of the three filters to selected ones of the outputs RXOUT1-RXOUT7. Referring again to FIG. 6-1, the antenna A3/ANT3, detects a third channel of B25/B66/B41 Rx, and the switch 622 connects ANT3 to P1. Thus, referring now to FIG. 6-3, the channel is received at antenna A2/ANT2 of the first MIMO module 606, and the switch 652 switch-combines to connect the diplexer 645 and the B41′ Rx filter to ANT2. The corresponding band switches in the set of band switches 618 receive the filtered signals and output the filtered signals to the corresponding receive amplifiers in the group of receive amplifiers 616 (B25′ Rx to MB4, B66′ Rx to MB3, B41′ Rx to HB3). The receive switch 611 connects the outputs of the three filters to selected ones of the outputs RXOUT1-RXOUT7. Thus, 3 Rx CA is achieved by the first PAMiD 602 and the first MIMO module 604. In a similar manner, an additional 3 Rx CA can be achieved by the second PAMID 604 and the second MIMO module 608, thereby achieving 6 Rx CA for B25/B66/B41.

In addition, the front-end system 600 implements interleaved ASM in the switches 622, e.g., with direct/separate B41 Tx/Rx connections, thereby preventing FDD Rx puncturing during B41 sounding reference signal (SRS) operation on the PAMID FDD Rx paths (2-of-4RX or 2-of-6RX). This is illustrated in FIGS. 7A and 7B, which show the configuration of the first PAMID 602 during different phases of an SRS cycle on B41.

FIG. 7A shows the first PAMID 602 during B41 SRS transmission on antenna A2 via ANT2. The transmit switch 610 connects TX2 to the high-band power amplifier 614. The second transmit band switch 631 connects the output of the high-band power amplifier 614 to the B41 transmit filter. The switch 622 connects the output of the B41 Tx path to A2/ANT2. Simultaneously, A2/ANT2 is receiving B25 Rx. The switch 622 switch-combines the B41 Tx filter and the hexaplexer 634 to ANT2/A2, thereby providing B25 Rx to the hexaplexer 634 while transmitting B41 Tx on ANT/A2. Separation of the B41 Tx filter from the hexaplexer 634 allows sufficient isolation between B41 Tx and B25 Rx to prevent puncturing of B25 Rx on ANT2/A2 during SRS B41 Tx on ANT2/A2. In this manner, the radio frequency front-end system 600 includes a set of radio frequency paths that includes a transmit path and a primary receive path for each of at least first, second, and third bands (e.g., B41, B25, B30), a first filter of the primary receive path for the second band (e.g., B25) ganged together (e.g., in the hexaplexer 634) with a second filter of the primary receive path for the third band (e.g., B30) and connected to the switch with a common connection, a third filter of the transmit path of the first band (e.g., B10) separate from the first and second filters. Moreover, the radio frequency front-end system is configurable during sounding reference signal transmission in the first band (e.g., B41) on the transmit path of the first band on a first antenna (e.g., A2), while simultaneously receiving on the first antenna in the second band (e.g., B25) on the primary receive path of the second band, without puncturing.

On the other hand, SRS puncturing may still occur when receiving on a MIMO channel. FIG. 7B shows B41 SRS Tx on antenna A2 while simultaneously receiving B25 Rx on a MIMO channel on A2. As shown, because B25 Rx is on the MIMO channel, the switch 622 can switch-combine B41 Tx with port P1, which connects to the switch 652 in the first MIMO module 606. Because the switch-combined connection between B41 Tx and B25 Rx is inter-module, it can be challenging to perform proper impedance matching, which can result in puncturing of B25 Rx. This is unlike the scenario of FIG. 7A, where the switch-combined connection between B41 Tx and Bw25 Rx is intra-module, entirely within the first PAMID 602.

Thus, according to the illustrated embodiment, of the six B25 Rx paths in the illustrated radio frequency system 600 (one in each PAMID 602, 604 and two in each MIMO module 606, 608), two of the six B25 Rx paths—those in the PAMiDs 602, 604—can be reliably protected from SRS B41 Tx puncturing. In a similar manner, separation of the B41 Tx filter can prevent puncturing on other bands. As one example, separation of B41 Tx filter from the B41 Rx filter can prevent puncturing of B41 Rx during B41 SRS Tx on the same antenna.

Moreover, in the first PAMID 602, the B40 TRx is a separate filter, e.g., separate from the pentaplexer 632 that includes the B1 filter, thereby allowing the similar non-punctured operation of certain bands such as B1 Rx during B40 SRS Tx on an antenna while simultaneously receiving B1 Rx on that antenna, at least for the primary path within the first PAMID module 602. However, in the illustrated front-end system, the second PAMID 604 does not have a B40 transmitter, unlike for B41. As such, because B40 SRS transmission in the second PAMiD module 604 will be inter-module and sourced from the first PAMID module 602 via the TRX port, it may be difficult to prevent puncturing of the B40 Rx path within the second PAMID module 604 (e.g., due to impedance matching challenges). Thus, puncturing may be reliably avoided on at least one of the four B40 Rx paths-on the path in the first PAMID module 602.

Because the front-end system 600 supports only four Rx on B40 but has six antennas, receive bands can be routed to other antennas to prevent puncturing during B40 SRS Tx. For example, referring to the receive band as “Band_A” (e.g., B1, B3, B32) in a B40+Band A_CA/ENDC scenario, reduced SRS-puncturing of Band A is enabled by the front-end module 600 by having a separate B40 Rx filter, e.g., by splitting the B40 Rx filter from the quadplexer 637 on the second PAMID 604. This can allow B40 Rx and Band A Rx to be reliably routed to different antennas during B40 SRS, and as a result incoming B40 SRS does not take over the Band_A antenna, preventing puncturing of Band_A on at least 2-out-of-4 paths.

Similarly, for B41+Band_B CA/ENDC scenarios where a receive band, referred to as “Band_B” (e.g., B3) supports a lower number of Rx paths than the maximum possible with the front-end system 600 (for example, 4 instead of 6), improved puncturing performance during SRS operation of B41 uplink (UL) can be achieved. Although B41 may support the maximum downlink (DL) paths (e.g., m-6), it is likely to support a lower number of data layers (e.g., n=4 in the illustrated embodiment). In such cases, B41 SRS signals are not expected to be transmitted by the UE from 2 out of the six antennas A1-A6 (or in general, m-n out of m). Thus, the front-end system 600 can be configured to route m-n Band_B RX signals to those B41 antennas that are not serviced by B41 SRS signals, when in this CA mode, thereby preventing SRS puncturing.

The front-end system 600 can also support B41+Band_C CA/ENDC, where Band_C is a TDD band that supports non-simultaneous Tx/Rx operation with B41 and sees similar considerations as the B41+Band_B case above, e.g., when Band_C supports no more than 4 Rx (or n<m Rx). B39 is an example case for Band_C.

During B39+Band_D CA/ENDC (Band_D is most commonly B41), a similar situation as the B40 CA case above can be encountered. As long as Band_D supports no more than 4 Rx (or n<m Rx), the same reasoning can apply as in the B40 CA case, and the system 600 can similarly be configured to prevent puncturing on m-n paths.

As shown, the front-end system 600 can additionally support NTN band coverage on the second PAMID 604 via one or more of the following:
n256: RX by extending the B1 RX filter, which can also cover B66 RX, as shown. This B1/66/n256 Rx filter is separated from B1 MUX (e.g., quadplexer 638) and B25 MUX (e.g., triplexer 639) on its own switch arm, so that it can be switch-plexed or switch-combined with either B1 MUX (e.g., quadplexer 638), B25 MUX (e.g., triplexer 639) or n256 TX (e.g., triplexer 637). For example, the switch 622 can switch-combine the B1/66/n256 Rx filter with the quadplexer 638 for full duplex B1 operation, with the triplexer 639 for duplex B66 operation, or with the n256 Tx filter for duplex n256 operation.
n256: TX supported by a dedicated n256 TX filter, hard-plexed with other NTN TX content. One alternative embodiment includes a single TX filter that that switches between B1 TX mode & n256 TX mode.
n255: TX by extending n254 TX upwards (16 MHz→50 MHz).
n255: RX can be supported in at least three different ways according to different embodiments: 1) dedicated filter (hard-plexed with other NTN TX content); 2) extending B32/75/76 filter upwards (90 MHz to 132 MHz); or 3) extending n74B filter upwards (30 MHz to 71 MHz), as illustrated. If n74B TX rejection is challenged, or if n74 is not present, then the other 2 options may be preferred.
n255 RX: According to certain embodiments, a 2nd n255 RX filter may be included in the first PAMiD 602, connected to a separate throw on the ASM, and sharing the existing LMB LNA through a separate input stage or pre-LNA switch throw.

Although the front-end system of FIG. 6 (including FIGS. 6-1 through 6-4) and FIGS. 7A-7B illustrate an example a front-end system in accordance with embodiments described herein, the front-end systems can be modified in a wide variety of ways, e.g., to support additional bands.

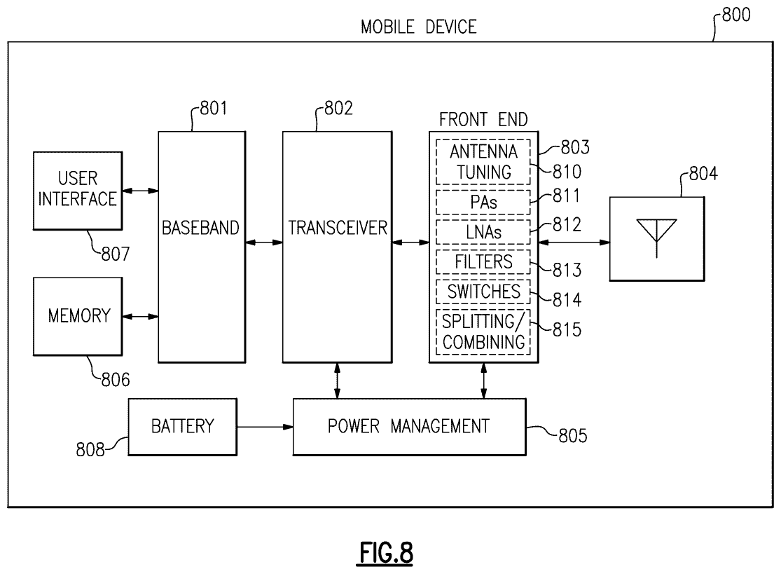

FIG. 8 is a schematic diagram of one embodiment of a mobile device 800. The mobile device 800 includes a baseband system 801, a transceiver 802, a front-end system 803, antennas 804, a power management system 805, a memory 806, a user interface 807, and a battery 808.

The mobile device 800 can be used communicate using a wide variety of communications technologies, including, but not limited to, 2G, 3G, 4G (including LTE, LTE-Advanced, and LTE-Advanced Pro), 5G NR, WLAN (for instance, WiFi), WPAN (for instance, Bluetooth and ZigBee), WMAN (for instance, WiMax), and/or GPS technologies.

The transceiver 802 generates RF signals for transmission and processes incoming RF signals received from the antennas 804. It will be understood that various functionalities associated with the transmission and receiving of RF signals can be achieved by one or more components that are collectively represented in FIG. 8 as the transceiver 802. In one example, separate components (for instance, separate circuits or dies) can be provided for handling certain types of RF signals.

The front-end system 803 aids in conditioning signals transmitted to and/or received from the antennas 804. The front-end system 803 can be any of the front-end systems described herein, such as the front-end system 600 of FIG. 6 or FIGS. 7A-7B, for example. In the illustrated embodiment, the front-end system 803 includes antenna tuning circuitry 810, power amplifiers (PAs) 811, low noise amplifiers (LNAs) 812, filters 813, switches 814, and signal splitting/combining circuitry 815. However, other implementations are possible.

For example, the front-end system 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 800 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 804 can include antennas used for a wide variety of types of communications. For example, the antennas 804 can include antennas for transmitting and/or receiving signals associated with a wide variety of frequencies and communications standards.

In certain implementations, the antennas 804 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 800 can operate with beamforming in certain implementations. For example, the front-end system 803 can include amplifiers having controllable gain and phase shifters having controllable phase to provide beam formation and directivity for transmission and/or reception of signals using the antennas 804. For example, in the context of signal transmission, the amplitude and phases of the transmit signals provided to the antennas 804 are controlled such that radiated signals from the antennas 804 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 804 from a particular direction. In certain implementations, the antennas 804 include one or more arrays of antenna elements to enhance beamforming.

The baseband system 801 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received signals provided by the transceiver 802. As shown in FIG. 8, the baseband system 801 is coupled to the memory 806 of facilitate operation of the mobile device 800.

The memory 806 can be used for a wide variety of purposes, such as storing data and/or instructions to facilitate the operation of the mobile device 800 and/or to provide storage of user information.

The power management system 805 provides a number of power management functions of the mobile device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE).

As shown in FIG. 8, the power management system 805 receives a battery voltage from the battery 808. The battery 808 can be any suitable battery for use in the mobile device 800, including, for example, a lithium-ion battery.

Table 1 below lists example frequency ranges for certain 3GPP (e.g., LTE and/or 5G) bands that have been discussed herein:

TABLE 1

| Band | Frequency range | | Duplex |
|---|---|---|---|
| B1 | 1920-1980 MHz UL / | | FDD |
| | 2110-2170 MHz DL | | |
| B3 | 1710-1785 MHz UL / | | FDD |
| | 1805-1880 MHz DL | | |
| B7 | 2500-2570 MHz UL / | | FDD |
| | 2620-2690 MHz DL | | |
| B11 | 1427.9-1452.9 MHz UL / | | FDD |
| | 1475.9-1500.9 MHz DL | | |
| B21 | 1447.9-1462.9 MHz UL / | | FDD |
| | 1495.9-1510.9 MHz DL | | |
| B25 | 1850-1915 MHz UL / | | FDD |
| | 1930-1995 MHz DL | | |
| B30 | 2305-2315 MHz UL / | | FDD |
| | 2350-2360 MHz DL | | |
| B32 | 1452-1496 | MHz DL | FDD |
| B34 | 2010-2025 | MHz | TDD |
| B39 | 1880-1920 | MHz | TDD |
| B40 | 2300-2400 | MHz | TDD |
| B41 | 2496-2690 | MHz | TDD |
| B53 | 2483.5-2495 | MHz | TDD |
| B66 | 1710-1780 MHz UL / | | FDD |
| | 2110-2200 MHz DL | | |
| n74 | 1462-1517 MHz UL / | | FDD |
| | 1475-1518 MHz DL | | |
| n75 | 1432-1517 | MHz DL | Supplemental |
| | | | downlink (SDL) |
| n76 | 1427-1432 | MHz DL | SDL |

| | | |
|---|---|---|
| n254 | 2020-2025 MHz UL / | FDD |
| | 2110-2120 MHz DL | |
| n255 | 1710-1780 MHz UL / | FDD |
| | 2110-2200 MHz DL | |
| n256 | 1980-2010 MHz UL / | FDD |
| | 2170-2200 MHz DL | |

### Applications

Some of the embodiments described above have provided examples in connection with mobile devices. However, the principles and advantages of the embodiments can be used for a wide range of RF communication systems. Examples of such RF communication systems include, but are not limited to, mobile phones, tablets, base stations, network access points, customer-premises equipment (CPE), laptops, and wearable electronics.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A radio frequency front-end system comprising:
at least a first primary module including: a set of radio frequency paths that includes a transmit path and a primary receive path for each of at least first and second bands; a set of ports that includes a plurality of antenna ports and a first secondary module port; and a switch connected between the set of radio frequency paths and the set of ports; and
at least a first secondary module including: a plurality of secondary receive paths including a first secondary receive path for each of the first and second bands; a first primary module port; and a first switch connected between the secondary receive paths and the first primary module port, the first secondary module port coupled to the first primary module port thereby connecting the first primary module to the first secondary module.

2. The radio frequency front-end system of claim 1 wherein the at least a first primary module includes a first primary module and a second primary module, and the at least a first secondary module includes a first secondary module and a second secondary module, the first secondary module port of the second primary module coupled to the first secondary module port of the second primary module.

3. The radio frequency front-end system of claim 2 wherein the plurality of secondary receive paths of both of the first and second secondary modules include first and second secondary receive paths for each of the first and second bands.

4. The radio frequency front-end system of claim 3 wherein the radio frequency front-end system includes six receive paths for each of the first and second bands.

5. The radio frequency front-end system of claim 4 wherein the first and second bands are 3GPP bands 7 and 41.

6. The radio frequency front-end system of claim 1 further comprising N antennas each connected to one of the plurality of antenna ports, the radio frequency system capable of uninterrupted receive in at least the primary receive path for the first band while simultaneously performing sounding reference signal transmission in the first band sequentially across the N antennas.

7. The radio frequency front-end system of claim 1 wherein the at least a first primary module includes only a single primary receive path for each of the at least first and second bands, and the at least a first secondary module is a receive-only module.

8. The radio frequency front-end system of claim 1 wherein the at least a first secondary module is a multi-input multi-output (MIMO) module.

9. The radio frequency front-end system of claim 1 wherein the at least a first primary module includes a set of radio frequency paths that includes a transmit path and a primary receive path for each of at least first, second, and third bands, a first filter of the primary receive path for the second band ganged together with a second filter of the primary receive path for the third band and connected to the switch with a common connection, a third filter of the transmit path of the first band separate from the first and second filters.

10. The radio frequency front-end system of claim 9 wherein the radio frequency front-end system is configurable during sounding reference signal transmission in the first band on the transmit path of the first band on a first antenna, while simultaneously receiving on the first antenna in the second band on the primary receive path of the second band, without puncturing.

11. The radio frequency front-end system of claim 1 wherein the transmit path and the primary receive path of the for the first band are shared and include a shared frequency tunable filter.

12. The radio frequency front-end system of claim 1 wherein the at least a first primary module includes a first primary module and a second primary module, the set of radio frequency paths of the first primary module further including a transmit path and primary receive path for a third band, and the second primary module further including a primary receive path for the third band but not a transmit path, the transmit path and the primary receive path of the first primary module for the third band sharing a frequency tunable filter connected via a common connection to the switch.

13. The radio frequency front-end system of claim 1 wherein the at least a first primary module includes a first primary module and a second primary module, the set of radio frequency paths of the second primary module further including a transmit path and a primary receive path for at least a first non-terrestrial network band.

14. The radio frequency front-end system of claim 13 wherein the set of radio frequency paths of the second primary module includes a transmit path and a primary receive path for at least first and second non-terrestrial network bands, the transmit path of the first and second non-terrestrial network bands sharing a common filter connected to the switch via a common connection.

15. The radio frequency front-end system of claim 13 wherein the primary receive path for the first non-terrestrial network band shares a filter with the primary receive path of the first band, which is a cellular band.

16. The radio frequency front-end system of claim 13 wherein the set of radio frequency paths of the first primary module further includes a primary receive path for at least the first non-terrestrial network band.

17. The radio frequency front-end system of claim 1 wherein the first primary module is a packaged module and the first secondary module is a packaged module.

18. A radio frequency front-end system comprising:
at least first and second primary modules each including: a set of radio frequency paths that includes a transmit path and a primary receive path for each of at least first and second bands; a set of ports that includes a plurality of antenna ports and a first secondary module port; and a switch connected between the set of radio frequency paths and the set of ports;
at least first and second secondary modules each including: a plurality of secondary receive paths including a first secondary receive path for each of the first and second bands; a first primary module port; and a first switch connected between the secondary receive paths and the first primary module port, the first primary module ports of the and second first secondary modules respectively coupled to the first secondary module ports of the first and second primary modules.

19. The radio frequency front-end system of claim 18 wherein the first and second primary modules and the first and second secondary modules are each separately packaged modules.

20. A mobile device comprising:
at least a first primary module including: a set of radio frequency paths that includes a transmit path and a primary receive path for each of at least first and second bands; a set of ports that includes a plurality of antenna ports and a first secondary module port; and a switch connected between the set of radio frequency paths and the set of ports;
at least a first secondary module including: a plurality of secondary receive paths including a first secondary receive path for each of the first and second bands; a first primary module port; and a first switch connected between the secondary receive paths and the first primary module port, the first secondary module port coupled to the first primary module port; and
a plurality of antennas each connected to a corresponding one the plurality of antenna ports.
